(19) United States
(12) Patent Application Publication
(10) Pub. No.: US 2014/0030463 A1
(43) Pub. Date: Jan. 30, 2014

(54) STRUCTURE OF SCREEN PROTECTOR

(71) Applicant: CHI-LIANG WEI, New Taipei City (TW)

(72) Inventor: CHI-LIANG WEI, New Taipei City (TW)

(21) Appl. No.: 13/557,232

(22) Filed: Jul. 25, 2012

(51) Int. Cl. B32B 3/02

(52) U.S. Cl. 428/58

(57) ABSTRACT

The invention is related to the structure of the screen protector adhered on a screen. The screen protector comprises a surface film layer made of PET or PMMA. The peripheral bottom of the surface film layer is covered by at least one printed adhesive layer. At least one ventilation portion is defined between the printed adhesive layers, wherein the printed adhesive layer comprises a printed layer covered beneath one side of the surface film layer and an attaching adhesive layer covered beneath one side of the printed layer. A gap is defined between the surface film layer and the screen, wherein the gap is connected with the ventilation portion. The design of the ventilation portion and the gap may help the air flow to prevent introducing the Newton ring besides protecting the screen and so as to achieve the practical improvement.

### TECHNICAL FIELD OF THE INVENTION

The present invention relates to the structure of the screen protector, and more particularly, to the structure of the screen protector which may help the air flow to prevent introducing the Newton ring.

### DESCRIPTION OF THE PRIOR ART

Normally, the electronic apparatus is easy to suffer the abrasion or scratch owing to the friction of using. Therefore, there are versatile screen protectors in the market and some usage of the screen protector has changed to protect the whole surface besides purely protecting the screen. However, the Newton ring (also called the rainbow pattern) is often produced because of the factors such as the vacuum induced inside no matter what the protector is used to protect the whole surface or just the screen and so as to lead the usage inconvenience.

### SUMMARY OF THE INVENTION

Thus, in view of the aforementioned disadvantages, the inventor invents the present invention, the structure of the screen protector which may help the air flow to prevent introducing the Newton ring, through continuously researching, testing, and modifying the related techniques according to the abundant experience in the art of the inventor.

The major objective of the present invention is to solve the problem that the Newton ring (also called the rainbow pattern) is often produced for the conventional screen protector because of the factors such as the vacuum induced inside and so as to lead the usage inconvenience.

To achieve the objective mentioned above, the present invention is to provide a structure of the screen protector, which comprises a surface film layer and a screen. The surface film layer is made of PET or PMMA, and the peripheral bottom of the surface film layer is covered by at least one print adhesive layer. At least one ventilation portion is defined between the print adhesive layers, wherein the print adhesive layer comprises a print layer covered beneath one side of the surface film layer and an attaching adhesive layer covered beneath one side of the print layer. A gap is defined between the surface film layer and the screen, wherein the gap is connected with the ventilation portion and the ventilation portion can make the air pass in and out to prevent producing the vacuum and so as to achieve the practical improvement of preventing the Newton ring induced by the vacuum.

### BRIEF DESCRIPTION OF THE DRAWINGS

FIG. 1 is a perspective view of the preferred embodiment according to the present invention.

FIG. 2 is an exploded view of the preferred embodiment according to the present invention.

FIG. 3 is a partial enlarged schematic diagram of the preferred embodiment according to the present invention.

FIG. 4 is a cross-sectional schematic diagram of the preferred embodiment according to the present invention.

FIG. 5 is an operational schematic diagram of the preferred embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

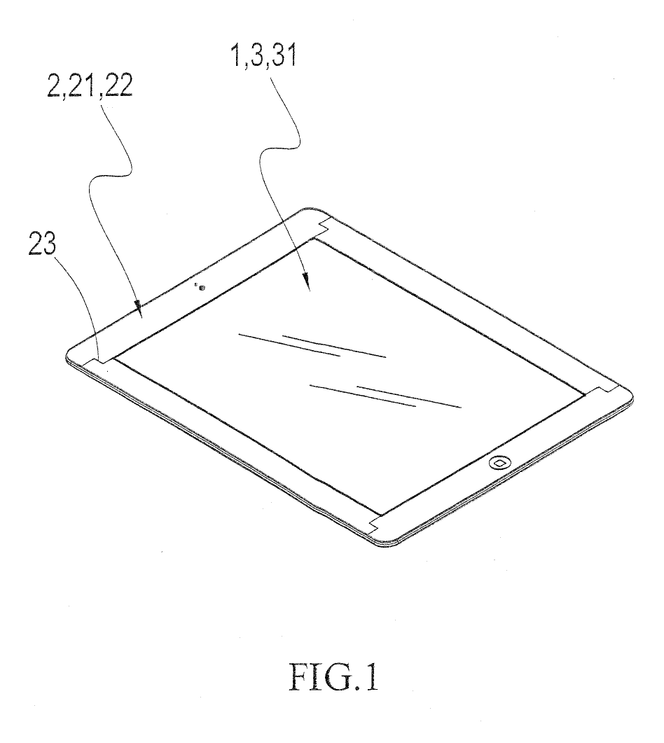

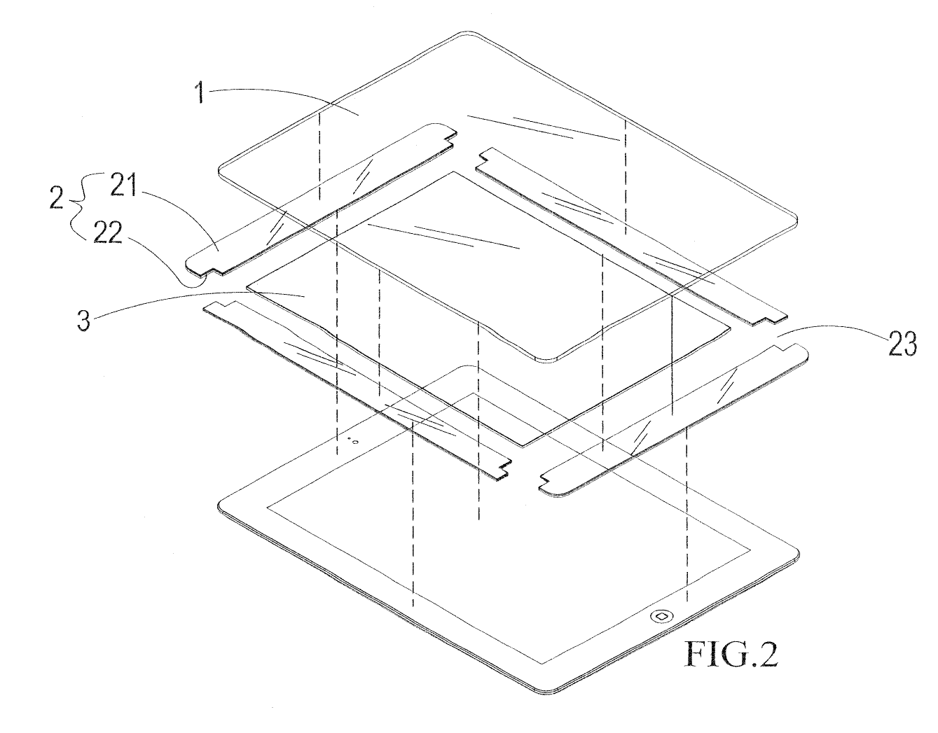

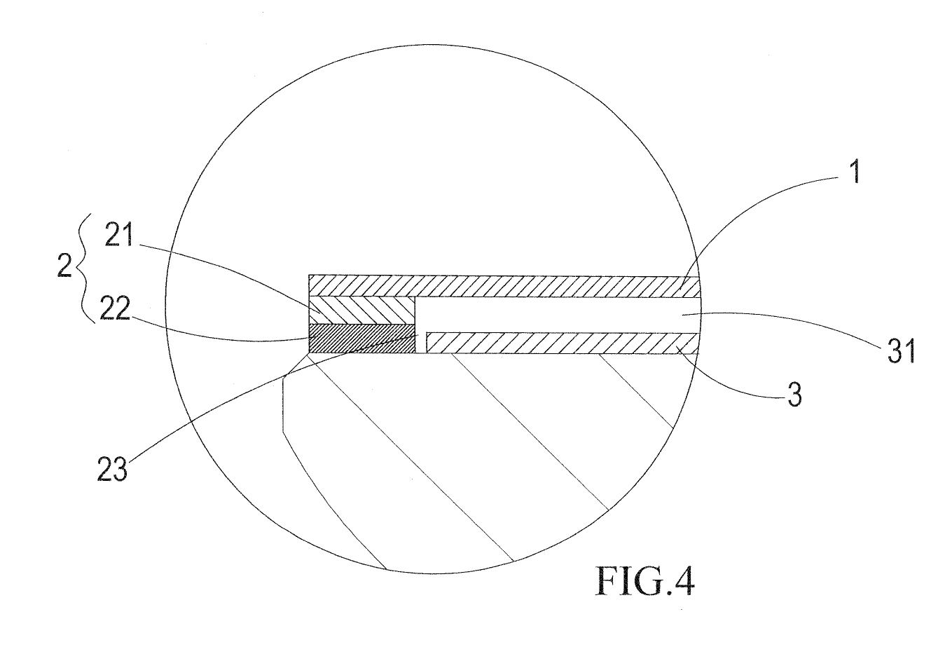

Please refer to FIG. 1 to FIG. 4, which are the perspective view, exploded view, partial enlarged schematic diagram, and cross-sectional schematic diagram of the preferred embodiment according to the present invention respectively. The structure of the screen protector of the present invention is clearly shown in the figures, which comprises a surface film layer 1 and a screen 3. The surface film layer 1 is made of PET or PMMA, and the peripheral bottom of the surface film layer 1 is covered by at least one print adhesive layer 2. At least one ventilation portion 23 is defined between the print adhesive layers 2, wherein the print adhesive layer 2 comprises a print layer 21 covered beneath one side of the surface film layer 1 and an attaching adhesive layer 22 covered beneath one side of the print layer 21. A gap 31 is defined between the surface film layer 1 and the screen 3, wherein the gap 31 is connected with the ventilation portion 23.

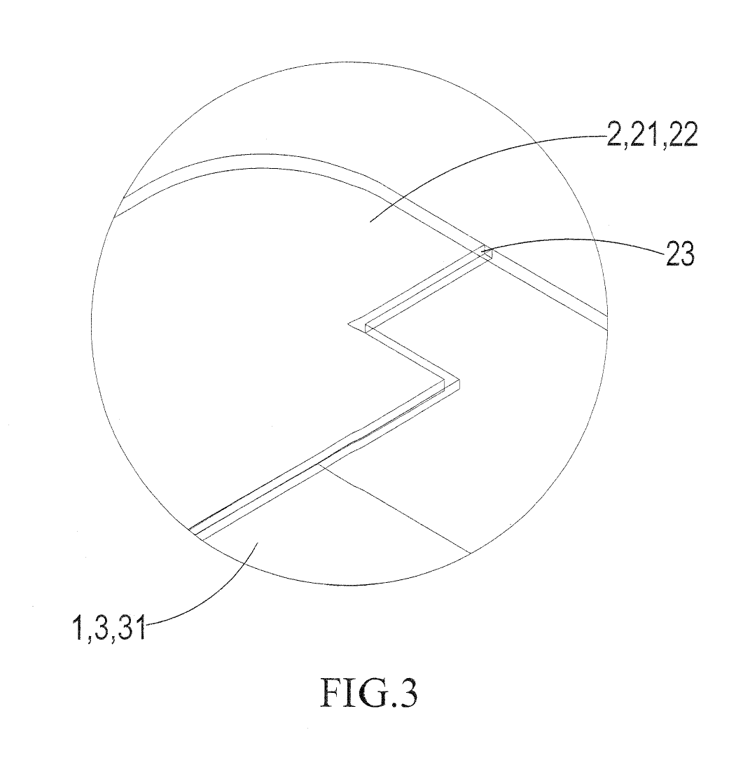

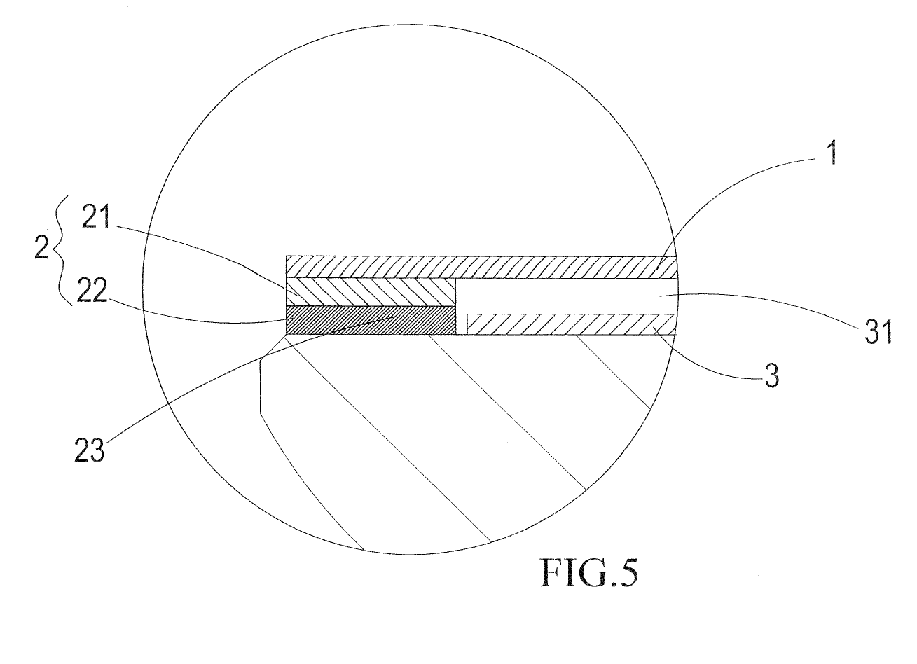

Through the above-described design of constitution and structure, the operation of the present invention is explained as follows. Please simultaneously refer to FIG. 3 to FIG. 5, which are the partial enlarged schematic diagram, cross-sectional schematic diagram, and operational schematic diagram of the preferred embodiment according to the present invention respectively. It is clearly shown in the figures, the surface film layer 1 is the PET or PMMA layer through the hardened process which can prevent the glare and have the function of abrasion endurance after the special processing. And, the print adhesive layer 2 covered beneath the surface film layer 1 comprises a print layer 21 which may have the decoration effect and correspond to the periphery of the tablet PC or other electronic apparatus. Further, the print adhesive layer 2 comprises an attaching adhesive layer 22 which can be washed by water and used to adhere multi-times repeatedly. Through the ventilation portion 23 defined by the print adhesive layers 2 and the gap 31 defined by the surface film layer 1 and the screen 3, the air can flow freely via the ventilation portion 23 to achieve the effect of preventing the induced Newton ring.

Thus, please refer to all attached figures, the present invention has the following advantages when comparing to the conventional techniques:
1. The surface film layer 1 is the PET or PMMA layer through the hardened process which can prevent the glare and have the function of abrasion endurance after the special processing.
2. The attaching adhesive layer 22 can be washed by water and used to adhere multi-times repeatedly.
3. Through the ventilation portion 23 and the gap 31 defined by the surface film layer 1 and the screen 3, the air can flow freely to achieve the effect of preventing the induced Newton ring.

I claim:

1. A structure of a screen protector, wherein the screen protector is adhered on a screen and comprises a surface film layer; wherein a peripheral bottom of the surface film layer is covered by at least one print adhesive layer and at least one ventilation portion is defined between the print adhesive layers; wherein a gap connected with the ventilation portion is defined between the surface film layer and the screen.

2. The structure of a screen protector according to claim 1, wherein the surface film layer is made of PET.

3. The structure of a screen protector according to claim 1, wherein the surface film layer is made of PMMA.

4. The structure of a screen protector according to claim 1, wherein the print adhesive layer comprises a print layer covered beneath one side of the surface film layer.

5. The structure of a screen protector according to claim 4, wherein the print adhesive layer comprises an attaching adhesive layer covered beneath one side of the print layer.
